(19) United States
(12) Patent Application Publication
(10) Pub. No.: US 2026/0278679 A1
(43) Pub. Date: Sep. 17, 2026

(54) SYSTEM AND COMPUTER IMPLEMENTED METHOD FOR FACILITATING THE TRANSACTION AND SETTLEMENT OF A FINANCIAL INSTRUMENT

(71) Applicant: AUSTRALIAN BOND EXCHANGE HOLDINGS LIMITED, Hornsby (AU)

(72) Inventors: Bradley Ronald McCosker, Manly (AU); Michael Vanderdonk, Banksia (AU)

(21) Appl. No.: 19/669,069

(22) Filed: May 6, 2026

Related U.S. Application Data
(63) Continuation of application No. 18/748,908, filed on Jun. 20, 2024.
Application No. 18/748,908 is a continuation of application No. 17/290,899, filed on Nov. 4, 2019, now abandoned.

(30) Foreign Application Priority Data
Nov. 2, 2018 (AU) 2018256664

(51) Int. Cl. G06Q 40/04; G06Q 20/02; G06Q 20/40

(52) U.S. Cl. CPC G06Q 40/04; G06Q 20/02; G06Q 20/4014

(57) ABSTRACT

A computer system for facilitating instantaneous settlement of a financial transaction by a central counterparty system. A validation module validates a client order prior to trade. For a buy order, the validation module is configured to: (a) automatically query one or more trusted data repositories for: —retrieving account data for a nominated funds account; —retrieving meta data associated with the client and/or trade, the meta data including at least one of (i) historical client trading data; and (ii) current market data; (b) implement one or more predictive algorithms to determine a likelihood of settlement for the buy order, utilising the retrieved data. Following validation of the order, implementing an order fulfilment module configured to place the order in a queue responsive to determining that the likelihood of settlement meets or exceeds a predefined threshold.

### FIELD OF THE INVENTION

This invention relates generally to a trading system and computer implemented method for transaction and settlement of products.

### BACKGROUND OF INVENTION

The traditional exchange clearing and settlement process remains virtually unchanged from the process created to suit the needs of physical share certificates and payments by cheque.

While exchanges all over the globe follow a similar model, the Australian Securities Exchange (ASX) can be used as an example. The ASX can be thought of as a centralised settlement facility. During the trading day, brokers transact with each other multiple times over multiple different stocks. This is shown diagrammatically in FIG. 1. These trades are usually on behalf of clients but can also be for the participant itself.

At the end of the trading day, though usually overnight, the process called “clearing” occurs where the ASX nets down all the buys and sells from each exchange participant and novates the netted movement per stock per broker to face the centralised counterparty. This process makes the clearing facility (no longer the exchange) the buyer to every seller and the seller to every buyer through the novation process. An end of day clearing process for the FIG. 1 example is diagrammatically represented in FIG. 2.

The result of clearing is to reduce each exposure to the netted down amounts of the day's trades. If the trade is on behalf of a client, the clearing participant guarantees the performance of its client. That is, the exchange is only concerned that the clearing participant makes good on the trades.

As new regulations have come out following the global financial crises, exchanges are asking for collateral to be posted to cover the credit risk for the period of time between trade execution and trade settlement (generally two working days). This margin generally represents about 10% in “cash market margin”.

Over the Counter (OTC) transactions allow securities to be traded via a decentralised dealer network as opposed to a centralised settlement facility such as the ASX. The traded securities may include debt securities, as well and other financial instruments, such as derivatives and “off market” transactions of exchange traded securities.

For OTC transactions there is no novation step as there is no centralised settlement facility. Each counterparty to an OTC transaction agrees the trade details (usually a trader) then the support staff agree the trade and settlement details and then settlement is made usually 2 days later.

Regulatory changes, again following the global financial crisis, pushed traditional OTC bi-lateral transactions to move to a centralised clearing model. According to this model the trades, while not executed on an exchange, are novated to a centralised clearing counterparty (CCP). CCPs are corporate entities (typically banks) that operate to reduce counterparty, operational, settlement, market, legal and default risk for participants. A CCP becomes the counterparty to the buyer and the seller and guarantees the terms of a trade even if one party defaults on the agreement. CCPs charge initial and variation margin to both sides of the transaction. This is an expensive solution to the problem of reducing counterparty (credit risk).

The settlement details of an OTC transaction can be negotiated at the time the transaction is entered into. At this time, the settlement date and the settlement facility where the delivery of the financial security and cash is also negotiated. While the general standard settlement period is two working days after the transaction is entered into, it can be any number of days.

For both OTC and exchange-based transactions the delay between deal execution and settlement is a throw-back from earlier times. Only a few decades ago, securities were in bearer form and a seller was required to deliver the physical share or bond certificate to the exchange as proof of ownership (the mail usually took 5 days). The purchaser would post a cheque to his broker who purchased the financial security on his behalf. Since the transaction process has become digital there has been a gradual reduction in the time between trade execution and settlement. However, even making the current in use process and systems as efficient as possible, most financial systems cannot reduce the timeframe to less than one day. There are two main limiting factors behind this. The first is that CCPs around the world typically use a batch processing system at the end of each trading day, at which point they novate all the trades between brokers to all face the exchange and net those transactions down to one net exposure per security. Secondly, the banks also net their transactions between each other where possible, so they can make a net transfer payment when they run their batch processes overnight.

Further, while the regulatory changes have resulted in more stabilised trading, each major clearing and settlement facility are required to hold billions of dollars in margins and default funds to use if there is a defaulting party to the exchange (it has been estimated that settlement failure rates amount to approximately 3% of all transactions).

It would be advantageous if there was provided a centralised trading system that could provide instantaneous settlement of financial instruments with minimal transaction costs, credit risk and operational risk.

### SUMMARY OF INVENTION

In accordance with a first aspect there is provided a computer system for facilitating instantaneous settlement of a financial transaction by a central counterparty system, comprising: an electronic trading platform comprising: a web server implementing a web application accessible by a user computing device, the web application configured to: receive, via the web application, a buy or sell order placed by a registered client or other authorised party operating on the client's behalf for a financial instrument; responsive to receiving the order, the web server configured to implement a validation module for validating the order prior to trade, wherein, for a buy order, the validation module is configured to: (a) automatically query one or more trusted data repositories for: —retrieving account data for a nominated funds account; —retrieving meta data associated with the client and/or trade, the meta data including at least one of (i) historical client trading data; and (ii) current market data; (b) implement one or more predictive algorithms to determine a likelihood of settlement for the buy order, utilising the retrieved data; following validation of the order, implementing an order fulfilment module configured to place the order in a queue responsive to determining that the likelihood of settlement meets or exceeds a predefined threshold; responsive to determining a matching order, immediately execute the trade and wherein the step of executing the trade comprises: the centralised trading system instantaneously novating and clearing the trade; withdrawing funds corresponding to the traded amount from the nominated funds account using an instant funds transfer process; and updating the inventory records for both clients to reflect the executed trade.

In an embodiment, for a sell order, the validation module is further configured to: (a) automatically query one or more trusted data repositories storing inventory data associated with the order; and (b) implement one or more predictive algorithms to determine a likelihood of settlement for the sell order, utilising the retrieved data.

In an embodiment, the order fulfilment module places the order in the queue in a position that is determined, at least in part, on the likelihood of settlement.

In an embodiment the position is additionally determined based on an order value and time of placement.

In an embodiment the order fulfilment module is further configured to automatically adjust one or more parameters of the order to increase the likelihood of settlement.

In accordance with a second aspect there is provided a method for facilitating instantaneous settlement of a financial transaction by a centralised trading system, the method comprising: receiving a registration request from a client wanting to trade a financial instrument at a future time; responsive to receiving the registration request, validating trading information for the client, the trading information comprising information identifying a nominated funds account that is accessible by the centralised trading system; responsive to validating the trading information, completing the registration for the client and storing the validated information in a client record maintained or accessible by the centralised trading system; post registration, receiving a buy or sell order placed by the registered client or other authorised party operating on the client's behalf for the financial instrument; validating the buy or sell order, wherein, for a buy order, the step of validating comprises evaluating the nominated funds account to establish that there are sufficient funds available for completing the trade and wherein, for a sell order, the step of validating comprises evaluating an inventory account to ensure that the client has sufficient inventory available to complete the trade; responsive to validating the buy or sell order, determining whether another registered client has placed a matching order; responsive to determining a matching order, immediately executing the trade and wherein the step of executing the trade comprises: the centralised trading system instantaneously novating and clearing the trade; withdrawing funds corresponding to the traded amount from the nominated funds account using an instant funds transfer process; and updating the inventory records for both clients to reflect the executed trade.

In an embodiment the trading information for the client further comprises identification information that can be used to verify the client's identify for satisfying prescribed regulatory requirements for the jurisdiction in which the centralised trading system is operating.

In an embodiment the trading information for the client further comprises inventory information that can be used to access an account for storing financial instrument inventory.

In an embodiment the nominated funds account is either owned by the client or a recognised sponsoring broker.

In an embodiment the method further comprises: placing each buy or sell order in a queue post verification.

In an embodiment the centralised trading system determines a match when the order placed by the client matches an order placed by another enrolled client up to the order size of the side with the smaller order.

In an embodiment the step of withdrawing funds from the buying client's nominated funds account comprises using the IS020022 or similar protocol for instantaneous funds transfer.

In an embodiment the method further comprises publishing all posted buy and sell orders such that all clients enrolled with the centralised trading system can view the posted orders.

In an embodiment the orders are placed over an electronic trading platform implemented by the centralised trading system.

In an embodiment the financial instrument comprises one of the following: securities, cash, derivatives, ICU's, and over the counter (OTC) products.

In an embodiment, for a buy order, in response to determining that there are insufficient funds in the client's nominated funds account the corresponding order is rejected.

In an embodiment, for a sell order, in response to determining that there is insufficient inventory the corresponding order is rejected.

In an embodiment the order specifies an order size and price.

In accordance with a third aspect there is provided a computer implemented method for facilitating instantaneous settlement of a financial transaction by a centralised trading system, the method comprising: receiving a registration request from a client wanting to trade a financial instrument or other instrument of value at a future time; responsive to receiving the registration request, validating trading information for the client, the trading information comprising information identifying a trading account that is accessible by the centralised trading system; responsive to validating the trading information, completing the registration for the client and maintaining a client record storing the validated information; post registration, receiving a buy or sell order placed by the registered client or other authorised party trading on the client's behalf for the financial instrument; validating the buy or sell order, wherein, for a buy order, the step of validating comprises evaluating the trading account to establish that there are sufficient funds or other tradable stock available for completing the trade and wherein, for a sell order, the step of validating comprises evaluating an inventory account to ensure that the client has sufficient inventory available to complete the trade; responsive to validating the buy or sell order, determining whether another registered client has placed a matching order; responsive to determining a matching order, immediately executing the trade and wherein the step of executing the trade comprises: the centralised trading system instantaneously novating and clearing the trade; instantly withdrawing funds or tradable stock corresponding to the traded amount from the buying client's trading account; and updating the inventory records for both clients to reflect the executed trade.

In accordance with a further aspect there is provided a computer implemented method for facilitating instantaneous settlement of a financial transaction by a centralised trading system, the method comprising: receiving a registration request from a client wanting to trade a financial instrument or other instrument of value at a future time; responsive to receiving the registration request, validating trading information for the client, the trading information comprising information identifying a nominated funds account that is accessible by the centralised trading system; responsive to validating the trading information, completing the registration for the client and maintaining a client record storing the validated information; post registration, receiving a buy or sell order placed by the registered client or an authorised party trading on the client's behalf for the financial instrument; determining whether another registered client has placed a matching order; validating the matching orders, wherein, for a buy order, the step of validating comprises evaluating the nominated funds account to establish that there are sufficient funds or other tradable stock available for completing the trade and wherein, for a sell order, the step of validating comprises evaluating an inventory account to ensure that the client has sufficient inventory available to complete the trade; responsive to validating the orders, immediately executing the trade and wherein the step of executing the trade comprises: the centralised trading system instantaneously novating and clearing the trade; instantly withdrawing funds or tradable stock corresponding to the traded amount from the buying client's nominated funds account; and updating the inventory records for both clients to reflect the executed trade.

In accordance with yet a further aspect there is provided a computer readable medium implementing a computer program comprising at least one instruction which, when implemented by a computer system, is operable to carry out the method as described in accordance with any one of the preceding aspects.

In a still further aspect there is provided a computer system for facilitating instantaneous settlement of a financial transaction by a central counterparty system, comprising: an electronic trading platform configured to: receive a registration request from a client wanting to trade a financial instrument at a future time; responsive to receiving the registration request, validate trading information for the client, the trading information comprising information identifying a nominated funds account that is accessible by the centralised trading system; responsive to validating the trading information, complete the registration for the client and storing the validated information in a client record maintained or accessible by the centralised trading system; post registration, receive a buy or sell order placed by the registered client or other authorised party operating on the client's behalf for the financial instrument; validate the buy or sell order, wherein, for a buy order, the step of validating comprises evaluating the nominated funds account to establish that there are sufficient funds available for completing the trade and wherein, for a sell order, the step of validating comprises evaluating an inventory account to ensure that the client has sufficient inventory available to complete the trade; responsive to validating the buy or sell order, determine whether another registered client has placed a matching order; responsive to determining a matching order, immediately execute the trade and wherein the step of executing the trade comprises: the centralised trading system instantaneously novating and clearing the trade; withdrawing funds corresponding to the traded amount from the nominated funds account using an instant funds transfer process; and updating the inventory records for both clients to reflect the executed trade.

### BRIEF DESCRIPTION OF THE DRAWINGS

Features and advantages of the present invention will become apparent from the following description of embodiments thereof, by way of example only, with reference to the accompanying drawings, in which:

FIG. 1 is a schematic illustrating conventional intra-day trading between exchange brokers;

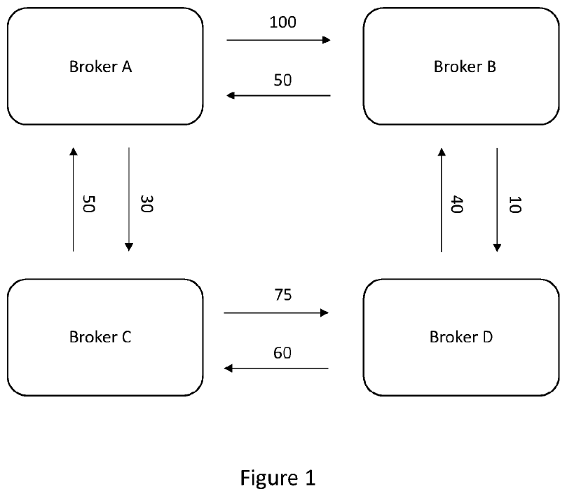

FIG. 2 is a schematic illustrating end of day clearing for the example of FIG. 1;

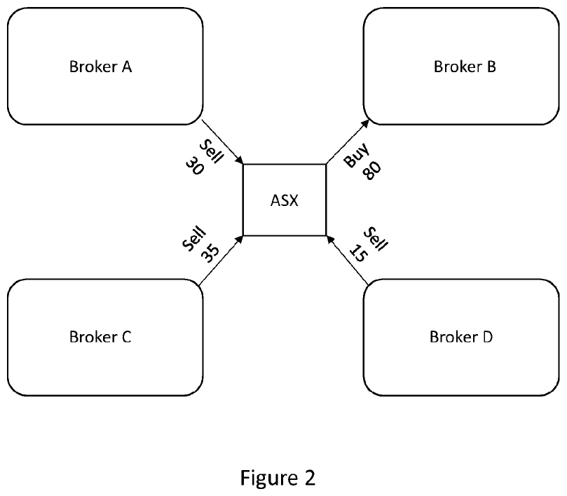

FIG. 3 is a schematic of a computer platform, in accordance with an embodiment;

FIG. 4 is a detailed process flow for a transaction and settlement procedure implemented by the centralised trading system shown in FIG. 3, in accordance with one embodiment.

### DETAILED DESCRIPTION OF PREFERRED EMBODIMENTS

Embodiments described herein relate to a trading system and computer implemented method for transaction and near real-time settlement of products. It will be understood that embodiments are suitable for trading any form of financial instrument, including, but by no means limited to, securities, cash, derivatives, ICUs, over the counter (OTC) products, and the like. Securities may include, for example, debt securities (e.g., loans, bank notes, bonds, debentures, and the like) and equity securities (e.g., stocks, warrants, convertible notes, hybrids and the like).

In general terms, the methodology comprises a plurality of distinct steps that are implemented by a centralised trading system that may take the form of a central counter party, trade execution venue, clearing and settlement facility, market maker system or the like.

The first step is referred to herein as the “pre-trade” step and involves a client registering with the centralised trading system. As part of the registration, the counter party's identity and payment information (e.g. trading account identifier) is validated by a computer implemented validation module of the centralised trading system. Once registered, a client record is created that stores the validated information. Once registered, the client can trade a financial instrument via the trading system by placing a buy or sell order via an order fulfilment module implemented by the centralised trading system.

Orders placed by the client are validated prior to trade. As will become evident from following paragraphs, the validation module may advantageously output accurate probability of settlement predictions at the time of order placement as well as price predictions based on settlement times. The predictions may be used for automated and dynamic queue placement determinations and/or transaction adjustments for optimising settlement likelihood and timeframe.

For a buy order, this involves evaluating the probability the client is able to pay for the asset. In more detail, this involves (a) automatically communicating with one or more trusted data sources for accessing account data for a client nominated funds account other asset repository and (b) determining the probability of delivering the asset or funds (or other asset in the case of an asset swap) to complete each side of the transaction using one or more predictive algorithms. In addition to inputting relevant account/asset data, the predictive algorithm(s) may communicate with one or more trusted data sources to determine historical client trading behaviour (such as previous trading and settlement activity for the specific participant and other participants that are statistically significant given trade, market, time and volume correlations), current market data (including price, market depth and volume indicators where available) and any other relevant inputs. The predictive algorithm then implements various statistical methods to output a score (or other suitable indicator) that is representative of the likelihood the trade will settle successfully. The predictive algorithm may, for example, apply statistical methods including, but not limited to, probability and rational choice theory based on past behaviour of the client (or clients that are regarded as similar to the client) to the trade, heuristics, framing and observable market inefficiencies including non-rational decision making and other behavioural economics based decision outcomes that are observable over a time period prior to the time of transaction. Based on the output of the validation module, the order fulfilment module may alter the behaviour of the transaction and settlement as described in subsequent paragraphs.

For a sell order, validation may involve the validation module (a) automatically accessing a mutually recognised and trusted inventory record or third party inventory record, and (b) implementing one or more predictive algorithms (e.g. using statistical methods that apply some formula, mathematical or computational model to one or more input variables) to determine the likelihood that the client will be able to trade that instrument and deliver the asset at settlement. Again, based on the output of the validation module, the order fulfilment module may alter the behaviour of the transaction and settlement as will be outlined in more detail in subsequent paragraphs.

Validated buy and sell orders are placed in an order queue by the order fulfilment module. For typical orders, the order fulfilment module will place the orders in the queue based on price and time received. However, where the output of the validation module is determinative of a predefined atypical order, the order fulfilment module may dynamically alter queue placement and/or adjust one or more order transaction parameters (e.g. trade volume, order settlement time, etc.) to increase the possible likelihood of settlement. According to a particular embodiment, the order fulfilment module may store a rule set storing implementation rules for predefined atypical order types.

The next step in the process is referred to herein as the “trade” step. In this step, the order fulfilment module determines a match between a buyer and a seller, but instead of passing the trade for later batch processing like all other financial exchanges, the module can use the output of the aforementioned predictive algorithm(s) implemented by the validation module to determine the probability of successful instantaneous completion of the transaction through to settlement. If the output(s) indicate that the level of success of trade completion is above a predefined threshold, then the order fulfillment module immediately executes the transaction by immediately buying from the seller and selling to the buyer. This enables the transaction life cycle to speed up, depending on the previously tracked behaviour of each party to a transaction to provide the computational potential to create the effect of instantaneous novation and clearing of the trade.

The relevant inventory records are subsequently updated to reflect the transaction and the funds instantaneously debited from the buyer's nominated funds account (e.g. using the ISO20022 universal financial industry message scheme). Each transaction is settled gross in real time and therefore there is no intraday credit given by the centralised trading system, as occurs in an end of day conventional CCP scenario.

The final step is referred to herein as the “post trade” step. Trades are registered in sequence to a data repository and trade details transmitted to the relevant regulatory authority and other stakeholders (such as market participants, data vendors, etc.). Additionally, information about the trade and settlement success is communicated back to the algorithms associated with the validation step to improve prediction validity and success.

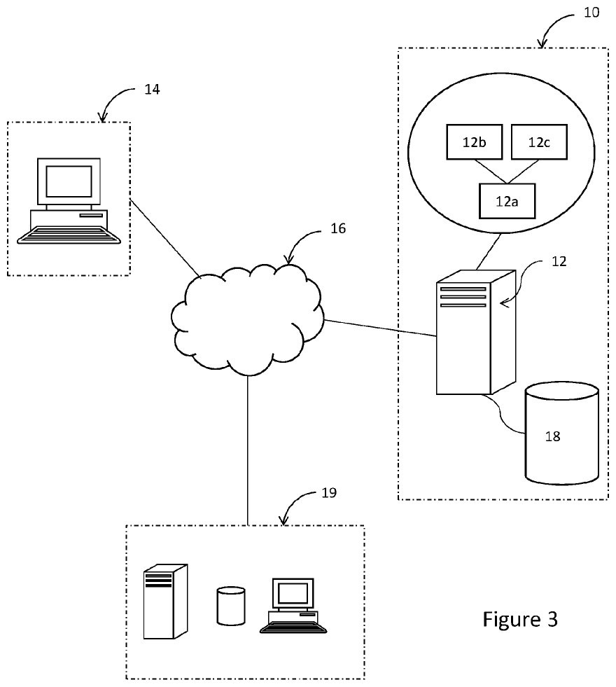

With additional reference to system schematic of FIG. 3, a centralised trading system 10 comprises an electronic trading platform. More particularly, according to the illustrated embodiment, the electronic platform is implemented by a web server 12 that hosts a web application 12a accessible by a user computing device 14 for client registration. The web application 12a is also configured to implement the validation module 12b and the order fulfilment module 12c that receives and fulfils orders placed by registered clients. As will be described in subsequent paragraphs, back-end processes operate to match buy and sell orders for instantaneous novation.

According to embodiments described herein, the web application 12a is accessible by way of a browser on any suitable network-enabled computing device 14, over the network 16. The network 16 may be any suitable fixed and/or mobile communications network, e.g., the Internet or a private intranet, and may use any suitable protocol for the exchange of electronic data, e.g., TCP/IP, NNTP, HTTP, etc. In an alternative embodiment, the application can be implemented as a native application installed on a personal user computer device (e.g. mobile phone, tablet, etc.), as will be well understood by persons skilled in the art.

The web server 12 is communicable with a local data store 18 that stores client and inventory (custody) records, as well as rule sets for the validation and order fulfilment modules 12b, 12c. The web server 12 is also configured to communicate with various remote trusted third-party services, data stores and regulatory bodies 19 over a network 16, e.g. for downloading data used for client/order validation, meeting regulatory reporting requirements, and updating inventory records that are held elsewhere, communicating with other stakeholders, and the like.

It will be understood that the aforementioned data stores can take any suitable digital form, from a standard SQL database to a distributed cloud store to a blockchain ledger.

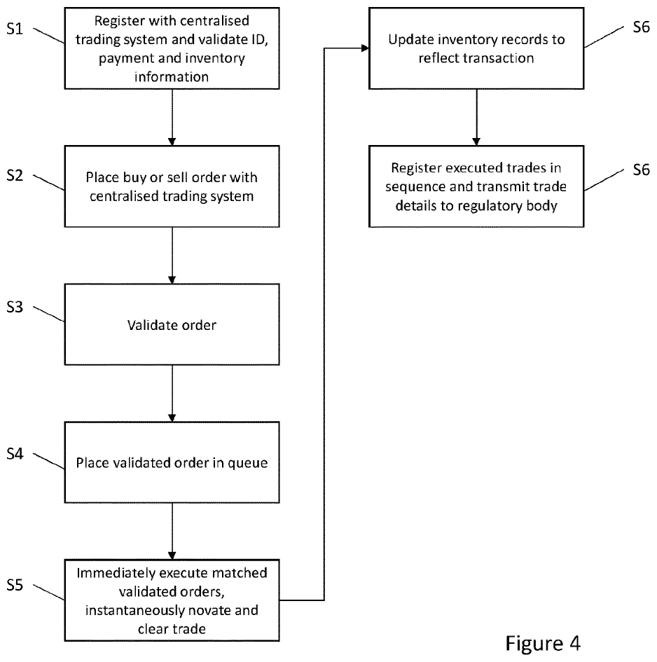

The afore-described trading steps will now be discussed in more detail with additional reference to the process flow diagram of FIG. 4. For ease of illustration, the process flow is described in the context of a financial instrument that is traded in exchange for cash. It will be understood, however, the payment method may be other than cash. For example, the payment medium could comprise any agreed upon medium that has a recognisable value between parties to both sides of the transaction (and the central trading system) including, but not limited to, commodities and ICUs.

At step S1 a client accesses the web application 12a via the web browser on their user computing device 14 and supplies various registration information requested by the centralised trading system 10. According to a particular embodiment, the requested information includes identification information for the client. The requested information may be information sufficient to allow the centralised trading system 10 to complete the “know your client” (KYC) regulatory requirements for the relevant jurisdiction. In one embodiment, the details are communicated to a KYC validation service which returns an indication as to whether the relevant requirements have been satisfied. It will be understood that the information for completing the KYC validation may be provided from a third party, such as a financial planner, that is working on behalf of the client.

By way of example, the KYC requirements for Australia require that the client pass an adequate “100 point” ID check for every individual involved. Another example of this is the European use of the Legal Entity Identifier (or LEI), a 20-character identifier that identifies distinct legal entities that engage in financial transactions. It is defined by ISO 17442. Individual involvement means every beneficial owner of a company or trust. Thus, as part of the registration, the client must provide sufficient information to enable the “100 point” ID check to be carried out.

Still at step S1, the client provides proof of available funds that can be used by the centralised trading system 10 to establish that purchases are able to be paid for at the time of execution (as opposed to the conventional T+2 industry standard). According to the illustrated example, the proof of available funds is communicated to the centralised trading system 10 as payment medium information taking the form of details for a nominated funds account (hereafter “trading account”) operated by the client.

According to a particular embodiment, proof of available funds (i.e. trading account validation) may be established by the validation module 12b confirming that funds can be withdrawn from the account, e.g. with an initial $0.01 transaction or similar. The validation module 12b of the centralised trading system 10 may perform ongoing validity checks, e.g. it may query the account once a day at 6 am (e.g. for a broker or institution or known high volume client), when a client logs into the system, and/or every time a client views an asset for purchase (direct purchase pre-check), or a combination of “push/pull” whereas when the account is opened the central trading system “pulls” the information from the nominated trading account, after which then there is a “push” from the nominated account if the balance drops below an agreed amount (most likely maximum trade size attributed to that account). Over that amount trades don't need to pull the balance as the balance would be more than adequate to settle any transaction, a balance under that amount would necessitate that the balance has to be pulled when the trade order is received. In addition, the validation module 12b may evaluate historical client trading behaviour (hereafter “behavioural trading data”). This may include evaluating local or remote trading records 19 for the client, or a client with similar asset and/or personal attributes, and then implementing predictive analytics (e.g. using neural nets, deep learning or other algorithms) to determine a likelihood that the client will be able to trade a particular instrument. It will be understood that the aforementioned validity checks should not be seen as limiting and that any suitable validity check for ascertaining proof of available funds or probability of funds being available in a timeframe to allow successful completion of the transaction through to settlement may be implemented.

In addition, if the client has an account holding inventory, the relevant inventory details are supplied and validated at step S1. Inventory details include appropriate identifiers for the instrument, such as a listing code, ISIN, Type, Industry, Issuer, etc. The inventory details also include transaction information such as holding volume, etc. The details may also be referenced to other datastores with common information such as instrument expiry, issue date, etc. These other datastores 18/19 may also be accessed by the validation module 12b in batch or real time to update client holdings with the ability to push (update on changes) or pull (refresh) updates. Further, tracking of behavioural trading data from each participant to the transaction, and other meta data relating to the client type and market conditions, including bank processing speeds at alternative and similar market scenarios can be pulled or otherwise fed back by the validation module 12b.

By way of example, the inventory details for a client that holds two assets for a bond exchange might be:
Client Name: Counter Party A
Client Unique Identifier: CL00001
Asset Identifier: XYZ0001
Total Holding: 100
Asset Identifier: ABX0001
Total Holding: 50

A new client record is subsequently generated by the web application 12a comprising the validated client identification information, payment medium information and inventory details. The record is stored in the local data store 18. At this point the client has completed the registration.

At step S2, the registered client accesses the order fulfilment module 12b and places a buy or sell order. The order includes an order price and volume (i.e. number of units) for a particular financial instrument. Alternatively, the order may take the form of an “at market” order where the price is automatically set and only the volume needs to be specified by the client, or any indeed any other iteration of order type accepted by the centralised trading system. For example, order types may include centre point, single fill MAQ, dark limits, sweeps, sweep dual post, centre point preferencing, day, good till cancel, good till date, good till time, fill or kill, immediate or cancel, among others. It will be understood that in an alternative embodiment to that described above, clients may use trading accounts through online brokers, bond trading platforms, robo-advice accounts, direct market access accounts, or otherwise through which their order is placed. Indeed, in one embodiment, the order fulfilment module 12b may implemented as a B2B direct interface or by way of an API that allows orders to be placed from the client or afore-described trading services. It will be understood that the order might be initiated via direct human interaction, or automatic depending on predetermined or programmatic methods.

When an order is received by the centralised trading system 10 it is immediately validated (step S3) by the validation module 12b in one of two ways, depending on whether the order is a buy order or a sell order. This validation is used to guarantee or assert likelihood of settlement of the order, at the time of placing the order.

By way of example, client A places their stock of 100 XYZ company units for sale (offer) on the system 10 for a price of $100 per share using the web application 12a. A second party (client B) will place a bid for 200 of that stock at $100 per share via an API based on a machine learning algorithm.

For a sell order, the validation module 12b of the centralised trading system 10 implements a probability algorithm that evaluates the inventory details for the client (which, as described above, may be held locally or remotely by a third party, such as a bank) to determine that the client has the inventory available, or is likely to have inventory available at a later date. Further, depending on the location and type of asset, the order fulfilment module 12c may subsequently change transaction parameters for the order, instant novation and settlement characteristics. For example, if the seller has an overseas bank account, the order fulfillment module may alter the settlement time from instant to T+2. This will result in the order being placed into a different position in the transaction queue by the order fulfilment module 12c. Third parties, such as a bank or other market participant can step in on behalf of the party on either side of the trade if that third party, though it's current inventory of the traded product or it's immediately accessible funds to step in on behalf of the party to the transaction and settle the transaction on their behalf if it increases the probability of improving the position of that part in the settlement queue.

If the inventory held under the client account is not equal to or greater than the order size, or the calculated settlement likelihood is below a certain threshold, then the order will be rejected by the order fulfilment module 12c (unless the seller has access to a securities lending agreement that is registered to the centralised trading system 10). Otherwise, the sell order is validated by the validation module 12b.

For a buy order, the validation module 12b of the centralised trading system 10 evaluates the client record to determine the nominated trading account which is subsequently automatically queried to retrieve account data representative of the amount of funds/available assets. The validation module subsequent implements a predictive algorithm that determines the likelihood that the client will be able to complete the order at a current or future time. Depending on the desired implementation, the validation module 12b may also query one or more local and/or remote database 18/19 to determine meta data associated with the client and/or trade. By way of example, the meta data may include historical trading data for the client and/or a client with similar trading or demographic attributes (e.g. the number of successfully completed orders, the largest order amount placed, or any other predefined relevant trading information). The meta data may also include current market data. In addition, the type of, or access to the account can alter the transaction. For example, a local account can be settled instantly while an international account is settled with T+2 to allow for funds transfer.

If the trading account does not currently have enough funds, or the likelihood of funds available is below a predefined threshold, then the order is instantly rejected. Otherwise the buy order is validated.

An exception case to an instant rejection is if another account registered for the client (such as a broker, through a broker sponsored trade) has sufficient funds or likelihood which will be debited to fund the transaction.

It will also be understood that the buy order validation may only be carried out when the order fulfilment module determines a matching sell order (as described below), or both when the order is received and any number of intervals up to and including the time of transaction execution.

It will also be understood that a trade volume/size can be marked as units, shares, lots, or any other common method to represent the count or number of instruments. It might also be marked as a dollar amount, e.g., buy $100,000 of XYZ.

When orders are verified as valid, at step S4 the order fulfilment module places them in an order queue. As discussed above, the placement may be based solely on price and time received, or adjusted based on an output of the validation module (i.e. where the output is used by the order fulfilment module to place orders that are more likely to be instantly settled higher in the queue, irrespective of price and time). In effect, ranking orders not only by price and time received but also the pairing between the set of buyers and sellers advantageously allows the trading system to complete transactions with the greatest speed from match to settlement.

Validated buy and sell orders are shared with registered clients to ensure timely and accurate price transparency. This may be in the manner of the order detail itself.

At step S5, responsive to determining a match between a buyer and seller, the centralised trading system 10 steps in to execute the transaction by becoming the buyer to the seller and a seller to the buyer (i.e. in effect acting as a centralised counter party, with both clients being counterparties to the trade). This creates the effect of instantaneous novation and clearing of the trade (i.e. allowing the centralised trading system 10 to execute the settlement of both trades simultaneously). As previously discussed, this part of the process flow is referred to as the “trade” step. It will be understood that a match is determined when a buy and sell order match each other on price up to the size of the side with the smaller order.

It will be understood that the transaction can also be an exchange faced transaction with no other enrolled client on the other side. In this case the centralised trading system 10 would take on both the role of settlement facility but also client.

With regards to transaction priority, according to the illustrated embodiment, the order fulfilment module 12c is programmed to recognise price priority before time priority. Table 1 below an example of orders placed with the trading system 10 over time:

TABLE 1

| # | Time | Price | Side | Volume |
|---|---|---|---|---|
| 1 | 10:43 | $100 | Sell | 250 |
| 2 | 10:45 | $90 | Buy | 100 |
| 3 | 10:46 | $100 | Buy | 100 |
| 4 | 10:47 | $100 | Buy | 100 |
| 5 | 10:48 | $99 | Buy | 100 |

As is evident from Table 1, transaction #1 matches with transactions #3 and #4 by price. Based on time priority, the order fulfilment module matches the sell order of #1 against the buy order of #3. However, that still leaves #1 with 150 units in inventory. Therefore, a second trade can be matched at $100 between the seller #1 and the buyer #4. This still leaves #1 with 50 units left of the order. So, the end result at this trading point is that #3 and #4 have bought 100 units each, #1 has sold 200 units, leaving the orders shown in Table 2 below to still be live (i.e. and ready to be matched).

TABLE 2

| # | Time | Price | Side | Volume |
|---|---|---|---|---|
| 1 | 10:43 | $100 | Sell | 50 |
| 2 | 10:45 | $90 | Buy | 100 |
| 5 | 10:48 | $99 | Buy | 100 |

As outlined in preceding paragraphs, the order fulfilment module 12c may dynamically adjust order placement and various transaction parameters for optimising trade settlement. Table 3 below shows an illustrative queue.

TABLE 3

| # | Time | Client | Side | Price | Volume |
|---|---|---|---|---|---|
| 1 | 10:43 | C1 | $100 | Sell | 250 |
| 2 | 10:45 | C2 | $99 | Buy | 100 |
| 3 | 10:46 | C3 | $100 | Buy | 150 |
| 4 | 10:47 | C4 | $100 | Buy | 100 |
| 5 | 10:48 | C1 | $97 | Buy | 100 |

Referring to Table 3, transaction #1 matches with transactions #3 and #4 by price. However, at the time transaction #1 is placed, the validation module 12b does not know about the C1 buy order that follows (#5) which might be required to fulfil the sell order #1. By examining C1's current holdings at 10:43, or by evaluating the probability C1 is holding enough assets (i.e. based on the predictive algorithm output of the validation module 12b), the order fulfilment module 12c may be programmed to either (a) accept order #1 as is as passed direct to settlement, (b) modify queue placement by delaying settlement to allow for the future buy transactions, or (c) modify the order to increase the likelihood of settlement. Some examples of these scenarios are outlined below.

In a first example, the validation module 12b determines that the client C1 has an existing asset volume of 1000. In this instance, the transaction #1 is passed for immediate matching and settlement and will fulfil transactions #3 and #4 assuming they also pass validation.

In a second example, the validation module may determine (based on the predictive evaluation) that the client C1 can't be guaranteed to hold enough volume of assets to sell, and transaction #1 does not meet a minimum threshold set for instant settlement. In this instance, the order fulfilment module 12c may place transaction #1 in a specific queue for delayed settlement, to allow for transaction #5 to take place first. This transaction might then be matched against transactions #3 and/or #4 depending on the outcome of validation of transactions #3 and #4.

In a further example, the validation module 12b may determine that C1 only holds 100 assets, and thus transaction #1 does not meet a minimum threshold. In this case, the order fulfillment module 12c may determine that a modified transaction #1 would result in an increased likelihood of settlement that does meet the minimum threshold. One specific example is the #1 transaction could be split in two, one transaction (#1.1) for immediate matching and settlement with a volume set to 100, and a second transaction (#1.2) for the remaining 150 set for delayed settlement. The #1.1 transaction would match and settle against transaction #3 (assuming validation of #3) and the #1.2 transaction would be delayed.

Matched trades are instantaneously cleared by the centralised trading system 10. As previously discussed, this involves determining the available funds for the buying client (i.e. previously validated and determined from the client record) and, using ISO20022 funds transfer protocol, withdrawing the relevant funds from that account. Once funds are confirmed, the trading system 10 determines the selling client's bank account (again, previously validated and determined from an evaluation of the client record) and transfers the withdrawn funds to that bank account. It will be understood that any suitable and regulatory prescribed funds transfer protocol/standard may be used for instantaneous funds transfer, depending on the jurisdiction and desired implementation.

At step S6, the centralised trading system 10 updates the relevant inventory records to reflect the transaction.

Post trade, at step S7, the centralised trading system 10 registers the executed trades in sequence to a database or series of database and trade details are transmitted to the relevant regulatory authority and other stake holders. The system also sends details about the order back to the validation process to improve future transactions. The database(s) may be any databases that are agreed to by the counterparties. In one embodiment, the centralised trading system may communicate a full data file (i.e. specifying the trade details, including the parties to the trade) to a database accessible by the regulator, while a redacted version may be sent to a database accessible by other stakeholders. Again, the database(s) may comprise any suitable data store or ledger. In a particular embodiment, the data file may be sent to a regulated single transaction log with micro second timings containing all asset pricing changes and trade execution will be regulated.

The afore-described system and methodology can be used for instantaneous 24/7 settlement capability of variation margin on derivative transactions, thereby moving the global derivatives margin away from batch processing each day (or multiple times a day) to a constantly calculated and margined on a price move basis instantaneously. Such a methodology may significantly reduce the risk in the global financial system. By way of example the initial transaction agreed by two registered clients that is cleared on the centralised trading system 10 will have two or three cash flow types. First will be any up-front payment (such as Credit Default Swaps that are traded under the “100/500” standard premium model) from one party to another to “even up” the derivative so that both parties are then at an equilibrium price. Then, according to some risk model such as VAR or SPAN, the centralised trading system 10 will demand initial margin from both parties to the trade. As persons skilled in the art will understand, initial margin is simply a payment made to the centralised counterparty (i.e. in this case centralised trading system 10) in the case of either party defaulting before the expiry of the derivative contract.

Then, at frequent intervals, the centralised trading system 10 charges a variation margin to both parties so that the value of the initial margin is not eroded due to price movement post the initial trade. This variation margin is performed on a batch process basis and should sum to zero to reflect the movement in the market. Using this derivative extension of this system 10 it is possible to margin clients based on an asynchronous output based on the aforementioned predictive algorithm of each market participant to speed up the currently accepted method of market move basis (i.e. the amount of change in the client portfolio as a result in price moves in the underlying security or the derivative itself). This creates an asynchronous risk mitigation system that can reduce the risk of loss given default by enabling instantaneous payment based on price moves in the positions of each client on a client by client basis in real time.

### Further Detail of System Configuration

The server 12 can be any form of suitable server computer that is capable of hosting suitably programmed web applications for communicating with clients, remotely implemented record stores, regulatory authorities and other stakeholders via suitably configured client computing devices over the network 16. The server 12 may include typical web server hardware including a processor, motherboard, memory, hard disk and a power supply. The server also includes an operating system which co-operates with the hardware to provide an environment in which software applications can be executed. In this regard, the hard disk of the server is loaded with a processing module which, under the control of the processor, is operable to implement engines for delivering the afore-described applications and modules.

The various aspects discussed herein may be implemented via any appropriate number and/or type of computer platform, modules, processors, memory, etc. each of which may be embodied in hardware, software, firmware, middleware and the like.

Further, it will be understood that the term “processor” as used herein is to be construed broadly and include within its scope any device that can process the relevant data/messages and may include a microprocessor, microcontroller, programmable logic device or other computational device, a general-purpose computer, or a server computer.

In an alternative embodiment, the computer platform may be implemented as a cloud-based application (i.e. in a secure web-based cloud environment), using techniques which will be well understood by persons skilled in the art.

According to the illustrated embodiment, the client computing devices take the form of general-purpose network enabled computers equipped with a browser. It will be appreciated, however, that the devices could be any suitable form of network-enabled computing device. For example, the devices may take the form of a special purpose device including a smart phone, tablet, or the like. Details of such devices (e.g. processor, memory, displays, data storage devices) are omitted for the sake of clarity.

At least one of the following advantages arises through implementing one or more embodiments of the invention as described herein:
Each transaction can be given a probability of success at the time the order is placed;
Standard portfolio risk calculations like SPAN are made invalid due to reducing the trade to settlement time to near instantaneous and identifying settlement probability at time of order;
Each transaction is settled on a gross bases at the time of transaction thereby eliminating intra-day credit risk and shortening the transaction life cycle down to almost instantaneous (as opposed to T+1 or greater, for conventional trading methods);
Settlement details are confirmed prior to each transaction taking place-thus reversing the typical steps in a financial transaction to reduce the incidence of operational and settlement failure;
Accurate prediction of prices can be calculated at time of order placement based off settlement time;
Improves market transparency by allowing counterparties access to the market who otherwise would not gain direct access because of the current need of centralised settlement facilities or CCPs to mitigate credit risk
more efficient collateral management capabilities for participants;
In the case of multiple centralised trading systems the potential to provide more accurate assessment of margin offsets, instantaneously settled cross border and cross currency transactions;
Ability for participants to calculate real time risk measurement on a 24/7/365 basis;
Removes the need for market close or downtime for clearing and batch settlement;
Removes the event of an entire batch failure if there is a transaction shortfall. Each trade is matched and settled on a trade by trade basis. Any failures will impact the specific trade only. This eliminates potential systemic risk in the global financial system;
Removes the need for posted collateral as insurance in case of participant default;
Access to an even playing field is allowed from central banks, exchanges, brokers and retail clients; and
Offers anonymity to the counterparties like a regular exchange.

While the invention has been described with reference to the present embodiment, it will be understood by those skilled in the art that alterations, changes and improvements may be made and equivalents may be substituted for the elements thereof and steps thereof without departing from the scope of the invention. In addition, many modifications may be made to adapt the invention to a particular situation or material to the teachings of the invention without departing from the central scope thereof. Such alterations, changes, modifications and improvements, though not expressly described above, are nevertheless intended and implied to be within the scope and spirit of the invention. Therefore, it is intended that the invention not be limited to the particular embodiment described herein and will include all embodiments falling within the scope of the independent claims.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1.-21. (canceled)

22. A computer system for facilitating instantaneous settlement of a financial transaction by a central counterparty system, comprising:
an electronic trading platform comprising:
a web server implementing a web application accessible by a user computing device, the web application configured to:
receive, via the web application, a buy or sell order placed by a registered client or other authorised party operating on the client's behalf for a financial instrument;
responsive to receiving the order, the web server configured to implement a validation module for validating the order prior to trade, wherein, for a buy order, the validation module is configured to:
(a) automatically query one or more trusted data repositories for:
retrieving account data for a nominated funds account;
retrieving meta data associated with the client and/or trade, the meta data including at least one of (i) historical client trading data; and (ii) current market data;
(b) implement one or more predictive algorithms to determine a likelihood of settlement for the buy order, utilising the retrieved data;
following validation of the order, implementing an order fulfilment module configured to place the order in a queue responsive to determining that the likelihood of settlement meets or exceeds a predefined threshold;
responsive to determining a matching order, immediately execute the trade and wherein the step of executing the trade comprises:
the centralised trading system instantaneously novating and clearing the trade;
withdrawing funds corresponding to the traded amount from the nominated funds account using an instant funds transfer process; and
updating the inventory records for both clients to reflect the executed trade.

23. A computer system in accordance with claim 22, wherein, for a sell order, the validation module is further configured to: (a) automatically query one or more trusted data repositories storing inventory data associated with the order; and (b) implement one or more predictive algorithms to determine a likelihood of settlement for the sell order, utilising the retrieved data.

24. A computer system in accordance with claim 22, wherein the order fulfilment module places the order in the queue in a position that is determined, at least in part, on the likelihood of settlement.

25. A computer system in accordance with claim 22, wherein the position is additionally determined based on an order value and time of placement.

26. A computer system in accordance with claim 22, wherein the order fulfilment module is further configured to automatically adjust one or more parameters of the order to increase the likelihood of settlement.

27. A computer implemented method for facilitating instantaneous settlement of a financial transaction by a centralised trading system, the method comprising:
receiving a registration request from a client wanting to trade a financial instrument or other instrument of value at a future time;
responsive to receiving the registration request, validating trading information for the client, the trading information comprising information identifying a trading account accessible by the centralised trading system, the trading account comprising at least one of:
(i) a nominated funds account; and
(ii) an account holding tradable stock or financial instrument inventory;
responsive to validating the trading information, completing the registration for the client and storing the validated information in a client record maintained or accessible by the centralised trading system;
post registration, receiving a buy or sell order placed by the registered client or other authorised party operating on the client's behalf for the financial instrument;
validating the buy or sell order, wherein, for a buy order, the step of validating comprises evaluating the trading account to establish that sufficient funds and/or tradable stock are available for completing the trade and wherein, for a sell order, the step of validating comprises evaluating an inventory account to ensure that the client has inventory available to complete the trade;
responsive to validating the buy or sell order, determining whether another registered client has placed a matching order;
responsive to determining a matching order, immediately executing the trade and wherein the step of executing the trade comprises:
the centralised trading system instantaneously novating and clearing the trade;
withdrawing funds or tradable stock corresponding to the traded amount from the trading account using an instant funds transfer process; and
updating the inventory records for both clients to reflect the executed trade.

28. A computer implemented method in accordance with claim 27, wherein the trading information for the client further comprises identification information that can be used to verify the client's identify for satisfying prescribed regulatory requirements for the jurisdiction in which the centralised trading system is operating.

29. A computer implemented method in accordance with claim 27, wherein the trading information for the client further comprises inventory information that can be used to access an account for storing financial instrument inventory.

30. A computer implemented method in accordance with claim 27, wherein the trading account comprises a nominated funds account that is either owned by the client or a recognised sponsoring broker.

31. A computer method in accordance with claim 27, further comprising: placing each buy or sell order in a queue post verification.

32. A computer implemented method in accordance with claim 27, wherein the centralised trading system determines a match when the order placed by the client matches an order placed by another enrolled client up to the order size of the side with the smaller order.

33. A computer implemented method in accordance with claim 27, wherein the step of withdrawing funds from the buying client's nominated funds account comprises using the IS020022 or similar protocol for instantaneous funds transfer.

34. A computer implemented method in accordance with claim 27, further comprising publishing all posted buy and sell orders such that all clients enrolled with the centralised trading system can view the posted orders.

35. A computer implemented method in accordance with claim 27, wherein the orders are placed over an electronic trading platform implemented by the centralised trading system.

36. A computer implemented method in accordance with claim 27, wherein the financial instrument comprises one of the following: securities, cash, derivatives, ICU's, and over the counter (OTC) products.

37. A computer implemented method in accordance with claim 27, wherein, for a buy order, in response to determining that there are insufficient funds and/or tradable stock in the trading account, the corresponding order is rejected.

38. A computer implemented method in accordance with claim 27, wherein, for a sell order, in response to determining that there is insufficient inventory in the trading account, the corresponding order is rejected.

39. A computer implemented method in accordance with claim 27, wherein the order specifies an order size and price.

40. A computer implemented method for facilitating instantaneous settlement of a financial transaction by a centralised trading system, the method comprising:
receiving a registration request from a client wanting to trade a financial instrument or other instrument of value at a future time;
responsive to receiving the registration request, validating trading information for the client, the trading information comprising information identifying a nominated funds account that is accessible by the centralised trading system;
responsive to validating the trading information, completing the registration for the client and maintaining a client record storing the validated information;
post registration, receiving a buy or sell order placed by the registered client or an authorised party trading on the client's behalf for the financial instrument;
determining whether another registered client has placed a matching order;
validating the matching orders, wherein, for a buy order, the step of validating comprises evaluating the nominated funds account to establish that there are sufficient funds or other tradable stock available for completing the trade and wherein, for a sell order, the step of validating comprises evaluating an inventory account to ensure that the client has sufficient inventory available to complete the trade;
responsive to validating the orders, immediately executing the trade and wherein the step of executing the trade comprises:
the centralised trading system instantaneously novating and clearing the trade;
instantly withdrawing funds or tradable stock corresponding to the traded amount from the buying client's nominated funds account; and
updating the inventory records for both clients to reflect the executed trade.
